(19) United States
(12) Patent Application Publication
(10) Pub. No.: US 2017/0026819 A1
(43) Pub. Date: Jan. 26, 2017

(54) OUT-OF-BAND HIDDEN NODE DETECTION

(71) Applicant: QUALCOMM Incorporated, San Diego, CA (US)

(72) Inventors: Qi Xue, San Diego, CA (US); Peerapol Tinnakornsrisuphap, San Diego, CA (US)

(21) Appl. No.: 14/808,433

(22) Filed: Jul. 24, 2015

(51) Int. Cl. H04W 8/00; H04L 5/00; H04L 29/08; H04W 72/08

(52) U.S. Cl. CPC H04W 8/005; H04W 72/082; H04L 5/0062; H04L 5/0073; H04L 67/1061

(57) ABSTRACT

Methods, systems, and devices are described for wireless communication. A wireless device, such as a station or an access point, may transmit a first out-of-band signal and may update a first list of neighboring devices based on receiving a second out-of-band signal from the neighboring devices. The device may exclude some neighboring devices from the first list based on the received signal strength indicator or the operating band of the neighboring device. The device may receive, from one or more associated peers, a second list of neighboring devices to the associated peer. The device may then compare its neighbor list to the neighbor list of its associated peer, and may identify additional neighbors in the associated peer's list that are unlisted in its own neighbor list, where the additional neighbors may operate on an overlapping channel. Based on the comparison, the device may change an operation mode before transmitting.

### BACKGROUND

The following relates generally to wireless communication, and more specifically to out-of-band hidden node detection.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as Wi-Fi (i.e., IEEE 802.11) network may include an AP that may communicate with one or more STAs or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

In some wireless systems, nodes may sense the medium before transmitting in order to prevent simultaneous transmissions with other devices. In some cases, a device may sense the medium but not detect one or more other nodes because they are beyond its sensing range. Thus, the device may not know when other nodes are transmitting. This may result in simultaneous transmissions to a central node, which may cause interference and corruption of the transmitted data. This interference may result in increased network overhead and may delay communication.

### SUMMARY

A wireless device, such as a station or an access point, may transmit an out-of-band signal and may update a first list of neighboring devices based on receiving a second out-of-band signal from the neighboring devices. The device may exclude some neighboring devices from the first list based on the received signal strength indicator or the operating band of the neighboring device. The device may receive, from one or more associated peers, a second list of neighboring devices to the associated peer. The device may then compare its neighbor list to the neighbor list of its associated peer, and may identify additional neighbors in the associated peer's list that are unlisted in its own neighbor list, where the additional neighbors may operate on an overlapping channel. Based on the comparison, the device may change an operation mode before transmitting.

A method of wireless communication is described. The method may include transmitting a first out-of-band signal, updating a first list of one or more neighboring devices based on receiving a second out-of-band signal from one or more neighboring devices, receiving, from one or more associated peers, a second list of one or more neighboring devices to the one or more associated peers, comparing the first list to the second list, and changing an operation mode based on the comparison.

An apparatus for wireless communication is described. The apparatus may include means for transmitting a first out-of-band signal, means for updating a first list of one or more neighboring devices based on receiving a second out-of-band signal from one or more neighboring devices, means for receiving, from one or more associated peers, a second list of one or more neighboring devices to the one or more associated peers, means for comparing the first list to the second list, and means for changing an operation mode based on the comparison.

A further apparatus for wireless communication is described. The apparatus may include a processor, memory in electronic communication with the processor, and instructions stored in the memory and operable, when executed by the processor, to cause the apparatus to transmit a first out-of-band signal, update a first list of neighboring devices based on receiving a second out-of-band signal from neighboring devices, receive, from associated peers, a second list of neighboring devices to the associated peers, compare the first list to the second list, and change an operation mode based on the comparison.

A non-transitory computer-readable medium storing code for wireless communication is described. The code may include instructions executable to transmit a first out-of-band signal, update a first list of neighboring devices based on receiving a second out-of-band signal from neighboring devices, receive, from associated peers, a second list of neighboring devices to the associated peers, compare the first list to the second list, and change an operation mode based on the comparison.

In some examples of the method, apparatuses, or non-transitory computer-readable medium described here, the first out-of-band signal is transmitted on a Bluetooth low energy (BLE) channel. Additionally or alternatively, in some examples the first out-of-band signal may include a media access channel (MAC) address, a hashed medium access control (MAC) address, a basic service set identification (BSSID), a hashed BSSID, an operation band, a channel number, a channel bandwidth, or any combination thereof.

In some examples of the method, apparatuses, or non-transitory computer-readable medium described here, the first list of neighboring devices may include a MAC address, a hashed MAC address, a BSSID, a hashed BSSID, an operation band, a channel number, a channel bandwidth, or any combination thereof for each neighbor. Additionally or alternatively, some examples may include processes, features, means, or instructions for comparing the first list and the second list that may include identifying additional neighbors in the second list that are unlisted in the first list, where the additional neighbors may operate on an overlapping channel. In some examples, the additional neighbors may be part of an overlapping basic service set.

Some examples of the method, apparatuses, or non-transitory computer-readable medium described herein may further include processes, features, means, or instructions for changing the operation mode that may include determining whether to transmit a request to send (RTS) message before sending a data message. Additionally or alternatively, some examples may include processes, features, means, or instructions for changing the operation mode may involve determining whether to transmit on a different operation band or with a different operation bandwidth. In some examples of the method, apparatuses, or non-transitory computer-readable medium described here, the operation mode is different for the one or more associated peers.

Some examples of the method, apparatuses, or non-transitory computer-readable medium described herein may further include processes, features, means, or instructions for excluding neighboring devices from the first list based on a received signal strength indicator (RSSI) of the neighboring device being below a threshold. Additionally or alternatively, some examples may include processes, features, means, or instructions for adjusting the RSSI based on the radio access technology of the second out-of-band signal or the operation band of the neighboring device.

Some examples of the method, apparatuses, or non-transitory computer-readable medium described herein may further include processes, features, means, or instructions for transmitting the first list of neighboring devices to the associated peers in a Wi-Fi packet or a Bluetooth packet or a Bluetooth low-energy packet. Additionally or alternatively, some examples may include processes, features, means, or instructions for receiving the second list of neighboring devices to the associated peers in a Wi-Fi packet or a Bluetooth packet or a Bluetooth low-energy packet.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a wireless communication system 100 that supports out-of-band hidden node detection in accordance with various aspects of the present disclosure

FIG. 2A-2B illustrates an example of a wireless communications subsystem that supports out-of-band hidden node detection in accordance with various aspects of the present disclosure;

FIG. 3 illustrates an example of a neighbor list comparison that supports out-of-band hidden node detection in accordance with various aspects of the present disclosure;

FIG. 4 illustrates an example of a process flow that supports out-of-band hidden node detection in accordance with various aspects of the present disclosure;

FIGS. 5-7 show block diagrams of a wireless device that supports out-of-band hidden node detection in accordance with various aspects of the present disclosure;

FIG. 8 illustrates a block diagram of a system including a STA that supports out-of-band hidden node detection in accordance with various aspects of the present disclosure;

FIG. 9 illustrates a block diagram of a system including an AP that supports out-of-band hidden node detection in accordance with various aspects of the present disclosure; and

FIGS. 10-12 illustrate methods for supporting out-of-band hidden node detection in accordance with various aspects of the present disclosure.

### DETAILED DESCRIPTION

In some radio access technologies (RATs) access to the medium may be contention-based, where the device senses the medium to determine if it is available or not before transmitting. In some cases, a first device may be transmitting to a central node but may be beyond the detection range of a second device. If the second device senses the medium, it may not detect the transmission of the first device and may begin transmitting, which may result in interference at the central node. These so-called hidden nodes may exist within the basic service set (BSS) or on a different, overlapping basic service set (OBSS). In other cases, some devices may not sense the medium before sending, which may result in interference if any other nearby device is also transmitting.

Some RATs may employ techniques to help prevent interference at a central node, such as carrier sense multiple access with collision avoidance (CSMA/CA). For example, in a wireless local area network (WLAN), nodes may sense the medium and send a request to send (RTS) control packet. If the receiving node is free, it may send a positive response, e.g., a clear to send (CTS) control packet. Nodes in a WLAN may represent one or more access points (APs) or stations (STAs) and together they may make up a BSS. In other cases, nodes may not use methods such as RTS/CTS. These nodes may cause interference any time the medium is occupied by another device.

Thus, as described herein, each node may transmit information on non-overlapping channels of the BSS in order to discover nearby devices, which may help identify hidden nodes. For example, devices connected to a Wi-Fi network may transmit using out-of-band Bluetooth low energy (BLE) channels. The transmission may contain the media access control (MAC) address, hashed MAC address, the basic service set identification (BSSID), hashed BSSID, the channel number on which the node is transmitting within the BSS, the channel bandwidth in which it is transmitting, or any combination thereof. A node may detect this transmission from its neighbors and may create a list of neighboring nodes. The node may then send its neighbor list to its associated peer or peers. For example, a STA may send its neighbor list to its associated AP, and an AP may send its neighbor list to all STAs connected to it. This information may be sent by a Wi-Fi data packet, a Bluetooth (BT) data packet, or BLE data packet. The list of neighbors may contain information for each neighboring device, for example, a neighbor's MAC address, hashed MAC address, BSSID, hashed BSSID, the channel number on which the neighbor is transmitting, the channel bandwidth in which it is transmitting, or any combination thereof.

Each node may then compare its own neighbor list with the neighbor list of its associated peer to determine if its associated peer has a neighbor that itself does not have, i.e., it may determine if a hidden node exists or not. Each device may then dynamically change its operating mode to prevent simultaneous transmissions, if needed. For example, if a node determines that a hidden node exists, it may then use CSMA/CS techniques, such as RTS/CTS, when transmitting. In another example, a node may change its operation bandwidth based on the operating channel of the hidden node. Or, the node may change its operation band based on the operation band of the hidden node. In other cases, the node may determine that no hidden nodes exist. For example, if no hidden nodes exist and the device senses the medium and determines that it is available, it may then transmit without RTS/CTS. In general, the operation mode for each associated peer may be different from other associated peers.

In some cases, the neighbor list may be filtered based on predetermined criteria. For example, the neighboring nodes may be filtered based on their received signal strength indication (RSSI) or filtered based on their operation band, or both. In some cases, the RSSI for a neighbor may be adjusted. For example, if the operation band is the same but the RAT is different, the RSSI may be adjusted to account for transmission power differences on different RATs. For example, if the operation band is 2.4 GHz, the transmission power differences between Wi-Fi and BLE may be accounted for. In other cases, the operation band of neighboring devices may be different. In this case, the list filtering may take into account a path loss difference. For example, if the operation band is 5 GHz, the path loss difference between 5 GHz and 2.4 GHz may be accounted for. In this case, a predetermined adjustment or range of adjustment may be used, for example, 6-8 dB for 2.4 GHz and 5 GHz. In other cases, a node may ignore a neighboring device if the BLE RSSI is lower than a predetermined threshold.

In some cases, a hidden node may exist within a BSS. In other cases, a hidden node may exist in an OBSS and operate on the BSS operation channel. Or, the hidden node in the OBSS may operate on a secondary channel. In each case, a node may determine to use CSMA/CS techniques, such as RTS/CTS, when transmitting. Additionally, a node may change its transmission bandwidth or its operation band before transmitting.

Aspects of the present disclosure are initially described in the context of a wireless communication system. Specific examples are then described for detecting hidden nodes through comparison of neighbor lists and then changing an operation mode based on the comparison. These and other aspects of the disclosure are further illustrated by and described with reference to apparatus diagrams, system diagrams, and flowcharts that relate to out-of-band hidden node detection.

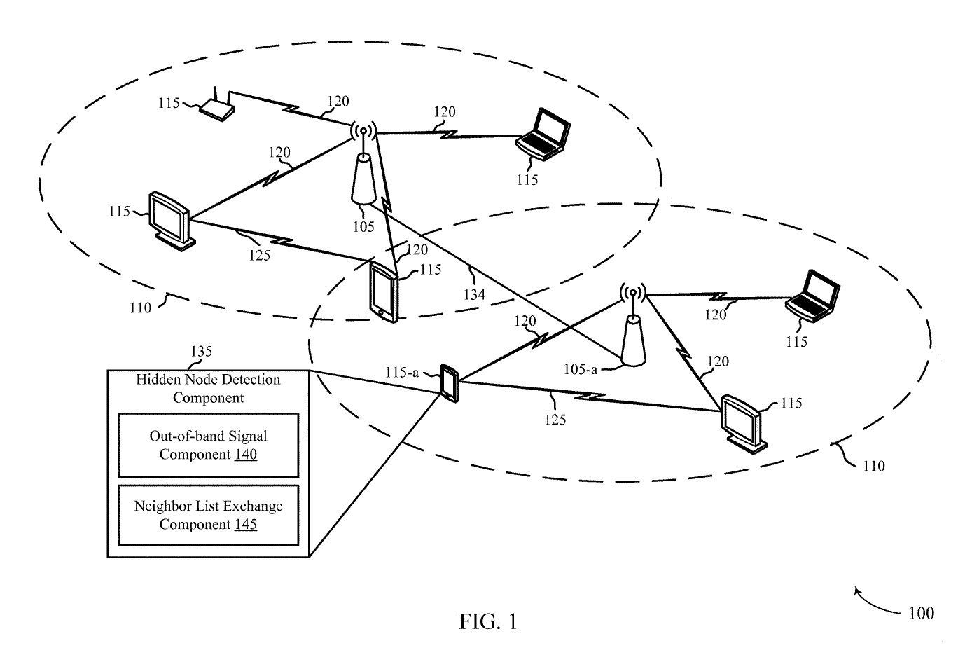

FIG. 1 illustrates an example of a wireless communication system 100 for out-of-band hidden node detection configured in accordance with various aspects of the present disclosure. Wireless communication system 100 may be an example of a wireless local area network (WLAN) (also known as a Wi-Fi network). Wireless communication system 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. Each AP 105 has a geographic coverage area 110 such that stations 115 within that area can typically communicate with the AP 105. Stations 115 may be dispersed throughout the geographic coverage area 110. Each station 115 may be stationary or mobile at various times. The AP 105 and the associated stations 115 may represent a BSS or an ESS. While only two APs 105 are illustrated, the WLAN network may have more than two APs 105. Each of the mobile devices 115, which may also be referred to as mobile stations (MSs), stations (STAs), nodes, mobile devices, access terminals (ATs), user equipment (UE), subscriber stations (SSs), or subscriber units, may associate and communicate with an AP 105 via a communication link 120. The various STAs 115 in the network are able to communicate with one another through the AP 105. In various examples, the APs 105 may communicate, either directly or indirectly with each other over the backhaul links 134, which may be wired or wireless communication links. An extended network station (not shown) associated with the wireless communication system 100 (e.g., WLAN) may be connected to a wired or wireless distribution system (DS) that may allow multiple APs 105 to be connected in an ESS. As used herein, the term “node” may apply to either an AP 105 or a mobile device 115.

While the mobile devices 115 may communicate with each other through the AP 105 using communication links 120, each mobile device 115 may also communicate directly with one or more other mobile devices 115 via a direct wireless link 125. Two or more mobile devices 115 may communicate via a direct wireless link 125. Examples of direct wireless links 125 may include Wi-Fi Direct connections, connections established using a Wi-Fi Tunneled Direct Link Setup (TDLS) link, Bluetooth connections, Bluetooth low energy connections, and other P2P group connections. Mobile devices 115 and APs 105 may communicate according to the WLAN radio and baseband protocol for physical (PHY) and medium access control (MAC). In other implementations, other peer-to-peer connections and/or ad hoc networks may be implemented within the wireless communication system 100.

A single AP 105 and an associated set of STAs 115 may be referred to as a BSS. An ESS is a set of connected BSSs. A distribution system (DS) (not shown) may be used to connect APs 105 in an ESS. In some cases, the coverage area 110 of an AP 105 may be divided into sectors (also not shown). The wireless communication system 100 may include APs 105 of different types (e.g., metropolitan area, home network, etc.), with varying and overlapping coverage areas 110.

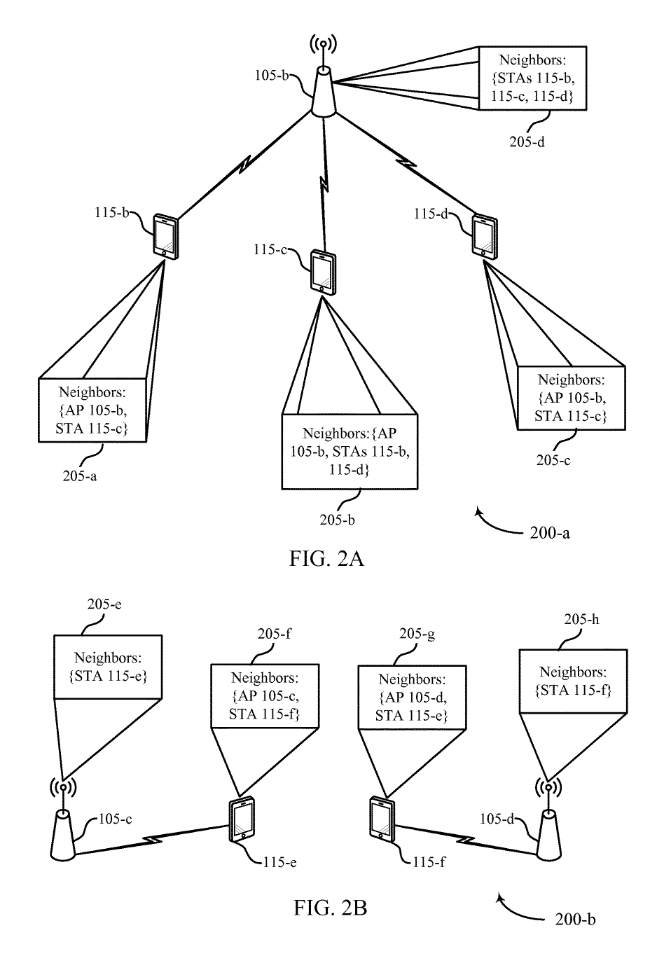

In some examples, one or more APs 105 or STAs 115 may include a hidden node detection component 135. While FIG. 1 illustrates the STA 115-a including the hidden node detection component 135, it is to be understood that a part or all of the functionality of the hidden node detection component 135 may be included on one or more of the APs 105. The hidden node detection component 135 may perform functionalities identified in the present disclosure, including those with reference to FIGS. 2-7. In some examples, hidden node detection component 135 is circuitry configured to perform such functionality. The hidden node detection component 135 may contain other components, including an out-of-band signal component 140 or a neighbor list exchange component 145. The out-of-band signal component 140 may transmit an out-of-band signal, for example, a signal on a BLE advertising channel. Each device may update a list of neighboring devices based on receiving a second out-of-band signal from the neighboring devices. Each device may exclude some neighboring devices from the first list based on the received signal strength indicator (RSSI) or the operation band. Each device may then receive from its associated peer or peers a second list of neighboring devices to the associated peer using the neighbor list exchange component 145. The hidden node detection component 135 may compare the two neighbor lists, and may identify additional neighbors in the associated peer's list that are unlisted in its own neighbor list, where the additional neighbors may operate on an overlapping channel. Based on the comparison, the hidden node detection component 135 may then change the operation mode of the device. For example, it may determine to implement or refrain from using CSMA/CA techniques such as RTS/CTS, or it may determine to transmit with a different bandwidth or on a different operation band.

In some cases, a STA 115 or AP 105 may operate in a shared or unlicensed frequency spectrum. These devices may perform a clear channel assessment (CCA) prior to communicating in order to determine whether the channel is available. A CCA may include an energy detection procedure to determine whether there are any other active transmissions. For example, the device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA may also include detection of specific sequences that indicate use of the channel. For example, another device may transmit a specific preamble prior to transmitting a data sequence.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem. The implementation of RTS/CTS may be dynamically changed for each associated peer based on whether a hidden node exists or not. A sending node may detect a hidden node by comparing its list of neighboring devices to the list of neighboring devices of the receiving node.

Wireless communication system 100 may operate on two primary levels: the MAC of the data link layer and the physical layer. The MAC sub-layer includes the distributed coordination function (DCF) and point coordination function (PCF). The DCF may be the basic access method, and may also be known as CSMA/CA. In DCF, each STA 115 may access the network independently using a collision avoidance protocol. For example, a STA 115 may wait for a DCF interframe space (DIFS) plus a random backoff period prior to transmitting to check whether another STA 115 is using the channel. The DCF may be implemented in all STAs 115. PCF may be implemented in selected STAs 115. In PCF, a single AP 105 coordinates the access for other STAs 115. DCF and the PCF may operate concurrently within the same BSS. For example, the two access methods may alternate, with a CFP for PCF followed by a contention period (CP) for DCF. An HCF may also be used, in which different traffic types are assigned different access priorities. In some cases, the use of CSMA/CA may depend on the comparison of the neighbor lists between the sending and receiving nodes.

In some cases, devices, such as STA 115 and AP 105, may be configured to operate using two or more radio access technologies (RATs). For example, a device may be configured to communicate over Wi-Fi, Bluetooth (BT), or Bluetooth low energy (BLE). Coverage area 110 may represent the coverage area for either RAT. These RATs may operate on similar frequencies but their channels may not overlap. For example, BT or BLE operate at 2.4 GHz, the same frequency as Wi-Fi. However, BLE advertising channels do not overlap with Wi-Fi channels. These advertising channels may be designed for low power and low data rates.

Thus, as described in the present disclosure, a wireless device, such as STA 115-a or AP 105-a, may transmit a first out-of-band signal using out-of-band signal component 140 and may update a first list of neighboring devices based on receiving a second out-of-band signal from the neighboring devices. The device may exclude some neighboring devices from the first list based on the RSSI or the operation band. The device may receive, from one or more associated peers, a second list of neighboring devices to the associated peer using neighbor list exchange component 145. The hidden node detection component 135 may compare its neighbor list to the neighbor list of its associated peer, and may identify additional neighbors in the associated peer's list that are unlisted in its own neighbor list, where the additional neighbors may operate on an overlapping channel. Based on the comparison, hidden node detection component 135 may change an operation mode.

FIG. 2A and FIG. 2B illustrate examples of a wireless communication subsystems 200-a and 200-b for out-of-band hidden node detection in accordance with various aspects of the present disclosure. Wireless communication subsystems 200-a and 200-b may include STAs 115-b through 115-f and APs 105-b through 105-d, which may be examples of a STA 115 and AP 105, respectively, as described with reference to FIG. 1. Neighbor lists 205-a through 205-h may be updated by each device by detecting out-of-band signals from neighboring devices. Each device may exchange its neighbor list with its associated peer(s) and may then compare its peer's neighbor list to its own list of neighbors to detect hidden nodes. Based on this comparison, each device may change its operation mode before transmitting.

Wireless communication subsystem 200-a in FIG. 2A represents a BSS consisting of STAs 115-b,c,d connected to AP 105-b. In general, a BSS can contain other combinations of STAs or APs. In some radio access technologies (RATs) access to the medium may be contention-based, where the device senses the medium to determine if it is available or not before transmitting. In some cases, a first device may be transmitting to a central node but may be beyond the detection range of a second device. For example, STA 115-d may be beyond the sensing range of STA 115-b. Thus, when STA 115-b transmits to AP 105-b, STA 115-b does not know whether STA 115-d is transmitting as well. This may result in interference at AP 105-b.

Some RATs may employ techniques to reduce interference at a central node, such as carrier sense multiple access with collision avoidance (CSMA/CA). For example, in wireless communication subsystem 200-a, STA 115-b may sense the medium and, if the medium is free, may send a request to send (RTS) control packet to AP 105-b. If AP 105-b is free, it may send a positive response, e.g., a clear to send (CTS) control packet. STA 115-b may then transmit to AP 105-b.

In some cases, RATs may operate on similar frequencies but their channels may not overlap. For example, Bluetooth (BT) or Bluetooth low energy (BLE) operate at 2.4 GHz, the same frequency as Wi-Fi. However, BLE advertising channels do not overlap with Wi-Fi channels. These advertising channels may be designed for low power and low data rates. STAs 115-b through 115-f and APs 105-b,c,d may be configured to operate using multiple RATs, for example, BT, BLE, or Wi-Fi.

Each node within the BSS in FIG. 2A may transmit information on non-overlapping channels of the BSS in order to discover nearby devices, which may help identify hidden nodes. For example, STAs 115-b,c,d and AP 105-b in FIG. 2A may transmit data over Wi-Fi and may also transmit information on a non-overlapping BLE channel. The out-of-band transmission may contain the node's media access control (MAC) address, hashed MAC address, the basic service set identification (BSSID), hashed BSSID, the channel number on which it is transmitting, the channel bandwidth in which it is transmitting, or any combination thereof. Each node may detect this transmission from its neighbors and may create a list of neighboring nodes, for example, neighbor lists 205-a through 205-d. Each node may then send its neighbor list to its associated peer or peers. For example, STA 115-b, STA 115-c, and STA 115-d may send its neighbor list to AP 105-b, and AP 105-b may send its neighbor list to each of STAs 115-b,c,d. This information may be sent by a Wi-Fi data packet, a BT data packet, or BLE data packet. The list of neighbors may contain information for each neighboring device, for example, a neighbor's MAC address, hashed MAC address, BSSID, hashed BSSID, the channel number on which the neighbor is transmitting, the channel bandwidth in which it is transmitting, or any combination thereof.

Each node may then compare its own neighbor list with the neighbor list of its associated peer to determine if its associated peer has a neighbor that it itself does not have, i.e., it may determine if a hidden node exists or not. For example, AP 105-b and STA 115-c may see more neighbors than STA 115-b or STA 115-d on the BSS operation channel, i.e, STA 115-b and STA 115-d may determine that hidden nodes exist. Each node may then change its operation mode based on the comparison of the neighbor lists. For example, when STA 115-b or STA 115-d transmit to AP 105-b, they may use RTS/CTS when transmitting. When STA 115-c transmits to AP 105-b, it may refrain from using RTS/CTS because it may determine that no hidden nodes exist. Thus, if STA 115-c senses the medium and detects no transmissions, then STA 115-c may infer that no other station is currently transmitting and may then transmit to AP 105-b without using resources such as RTS/CTS. When AP 105-b transmits to STA 115-b, STA 115-c, or STA 115-d, it may refrain from using RTS/CTS because it may determine that neither of the stations have neighbors in addition to its own neighbors.

Wireless communication subsystem 200-b in FIG. 2B represents a first BSS consisting of STA 115-e connected to AP 105-c and a second, overlapping BSS that consists of STA 115-f connected to AP 105-d. The service range of these BSSs may overlap and the BSSs may operate on the same operation channel. In general, the BSS or OBSS can contain other combinations of STAs or APs, and more than one OBSS may exist.

Each node may transmit information on non-overlapping channels of the BSS in order to discover nearby devices, which may help identify hidden nodes. For example, STAs 115-e,f and APs 105-c,d in FIG. 2B may transmit data over Wi-Fi and may also transmit information on a non-overlapping BLE channel. The out-of-band transmission may contain the node's media access control (MAC) address, hashed MAC address, the basic service set identification (BSSID), hashed BSSID, the channel number on which the node is transmitting, the channel bandwidth in which it is transmitting, or any combination thereof. Each node may detect this transmission from its neighbors and may update a list of neighboring nodes, for example, neighbor lists 205-e through 205-h. Each node may then send its neighbor list to its associated peer or peers. For example, STA 115-e may send its neighbor list to AP 105-c and vice versa. Likewise, STA 115-f may send its neighbor list to AP 105-d and vice versa. This information may be sent by a Wi-Fi data packet, a BT data packet, or BLE data packet. The list of neighbors may contain information for each neighboring device, for example, a neighbor's MAC address, hashed MAC address, BSSID, hashed BSSID, the channel number on which the neighbor is transmitting, the channel bandwidth in which it is transmitting, or any combination thereof.

Each node may then compare its own neighbor list with that of its associated peer to determine if its associated peer has a neighbor that it itself does not have, i.e., it may determine if a hidden node exists or not. For example, a hidden node may exist in the OBSS. In this case, STA 115-e may have more neighbors than AP 105-c on the BSS operation channel. For example, STA 115-f, which may be connected to the OBSS, may be a neighbor to STA 115-e, but not to AP 105-c. Each node may then change its operation mode based on the comparison of the neighbor lists. For example, STA 115-e may refrain from using RTS/CTS when transmitting to AP 105-c because it may determine that no hidden nodes exist. On the other hand, AP 105-c may implement RTS/CTS when transmitting to STA 115-e because it may determine that STA 115-e has an extra neighbor in the OBSS. Similarly, STA 115-f may have more neighbors than AP 105-d on the BSS operation channel. STA 115-f may refrain from using RTS/CTS when transmitting to AP 105-d, whereas AP 105-d may implement RTS/CTS when transmitting to STA 115-f.

In some cases, the nodes of an OBSS may operate on different channels, i.e., a hidden node may operate on a secondary channel in an OBSS. For example, STA 115-e may be connected to AP 105-c on a primary channel. STA 115-f may be connected to AP 105-d on a secondary channel and may represent an OBSS. In this case, STA 115-e may see more neighbors than AP 105-c on a secondary channel, e.g., STA 115-f operating on the secondary channel. When STA 115-e transmits to AP 105-c, it may refrain from using RTS/CTS because it may determine that no hidden nodes exist. When AP 105-c transmits to STA 115-e, it may have options for implementing RTS/CTS or not. For example, AP 105-c may use RTS/CTS to transmit on the full channel bandwidth. Or, AP 105-c may transmit without using RTS/CTS by reducing its bandwidth in order to eliminate interference with STA 115-f operating on the secondary channel. In the case of STA 115-f, it may see more neighbors than AP 105-d on the primary BSS operation channel. When STA 115-f transmits to AP 105-d, it may refrain from using RTS/CTS because it may determine that no hidden nodes exist. When AP 105-d transmits to STA 115-f, it may use RTS/CTS because it may determine that a hidden node exists and is operating on the primary channel. In other cases, nodes may change the operation band to prevent interference. For example, AP 105-d may change from the 2.4 GHz band to the 5 GHz band.

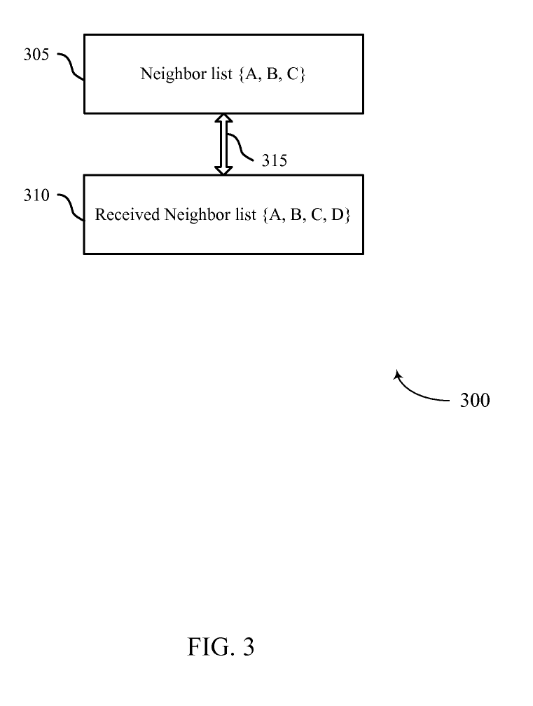

FIG. 3 illustrates an example of a neighbor list comparison 300 for out-of-band hidden node detection in accordance with various aspects of the present disclosure. Neighbor list comparison 300 may include a first neighbor list 305, a second, received neighbor list 310, and a comparison 315. Neighbor list comparison 300 may be performed by an individual device, such as a STA 115 or an AP 105. Neighbor list comparison 300 may aid in detecting hidden nodes.

Neighbor list 305 may be updated by receiving an out-of-band signal from neighboring devices. Received neighbor list 310 may be received from an associated peer to the device. Comparison 315 may be performed by the device to compare neighbor list 305 to received neighbor list 310. Comparison 315 may identify a neighbor in received neighbor list 310 that is not contained in neighbor list 305. For example, comparison 315 may determine that received neighbor list 310 has a neighbor ‘D’ not contained in neighbor list 305. Based on this comparison, the device may change its operation mode before transmitting.

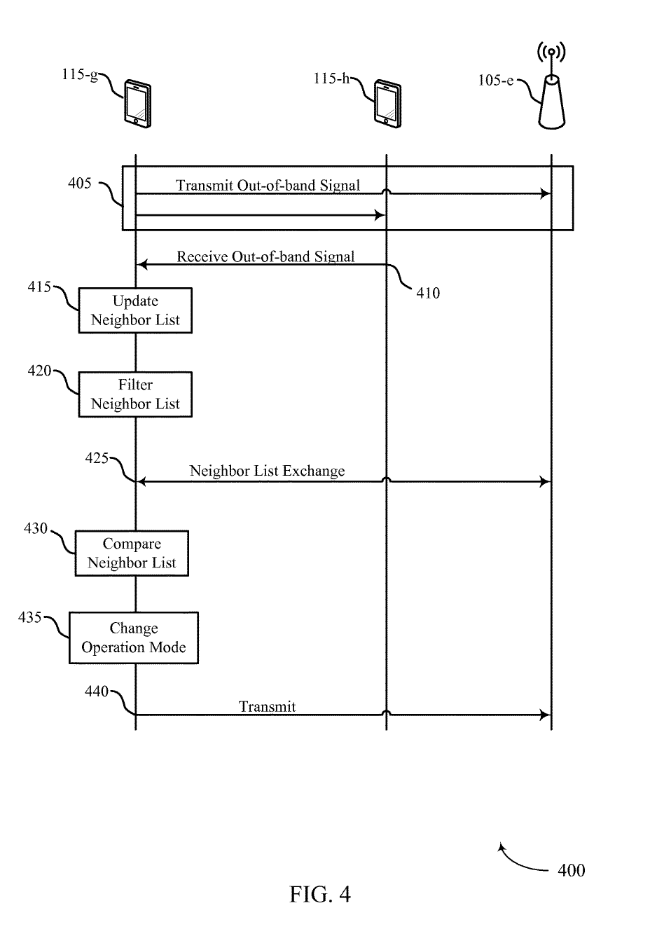

FIG. 4 illustrates an example of a process flow 400 for out-of-band hidden node detection in accordance with various aspects of the present disclosure. Process flow 400 may include a STA 115-g, STA 115-h, and AP 105-e, which may be examples of a STA 115 and AP 105 described with reference to FIGS. 1-2.

At 405, STA 115-g may transmit a first out-of-band signal. In some examples, the first out-of-band signal is transmitted on a Bluetooth low energy (BLE) channel and may comprise a media access channel (MAC) address, a hashed MAC address, a basic service set identification (BSSID), a hashed BSSID, an operation band, a channel number, a channel bandwidth, or any combination thereof.

At 410, STA 115-g may receive a second out-of-band signal from neighboring STA 115-h. In some examples, the first out-of-band signal is transmitted on a Bluetooth low energy (BLE) channel and may comprise a media access channel (MAC) address, a hashed MAC address, a basic service set identification (BSSID), a hashed BSSID, an operation band, a channel number, a channel bandwidth, or any combination thereof.

At 415, STA 115-g may update a first list of one or more neighboring devices based on receiving the second out-of-band signal at 410.

At 420, STA 115-g may filter its neighbor list. In some cases, STA 115-g may exclude one or more neighboring devices from the first list based on a received signal strength indicator (RSSI) of the neighboring device being below a threshold. In some instances, STA 115-g may adjust the RSSI based on the radio access technology of the second out-of-band signal or it may adjust the RSSI based on an operation band of the one or more neighboring devices.

At 425, neighbor lists of associated peers may be exchanged. For example, STA 115-g may send its neighbor list to AP 105-e and STA 115-g may receive a second list of one or more neighboring devices to AP 105-e. In some examples, the first list of one or more neighboring devices may include a media access channel (MAC) address, a hashed MAC address, a basic service set identification (BSSID), a hashed BSSID, an operation band, a channel number, a channel bandwidth, or any combination thereof for each neighbor. In some examples, STA 115-g may transmit the first list of one or more neighboring devices to the one or more associated peers in a Wi-Fi packet or a Bluetooth packet or a Bluetooth low-energy packet. In some examples, the second list of one or more neighboring devices to the associated peer may contain a media access channel (MAC) address, a hashed MAC address, a basic service set identification (BSSID), a hashed BSSID, an operation band, a channel number, a channel bandwidth, or any combination thereof for each neighbor. STA 115-g may receive the second list of one or more neighboring devices to the one or more associated peers in a Wi-Fi packet or a Bluetooth packet or a Bluetooth low-energy packet.

At 430, STA 115-g may compare the first list to the second list. In some cases, STA 115-g may identify one or more additional neighbors in the second list that are unlisted in the first list, where the one or more additional neighbors operate on an overlapping channel. In some examples, the one or more additional neighbors are part of an overlapping basic service set.

At 435, STA 115-g may change an operation mode based on the comparison of neighbor lists. In some cases, STA 115-g may determine whether to transmit a request to send (RTS) message before sending a data message. In other cases, STA 115-g may determine whether to transmit using a different operation bandwidth or to transmit on a different operation band. In some examples, the operation mode is different for the one or more associated peers.

At 440, STA 115-g may transmit to AP 105-e using the operation mode as determined.

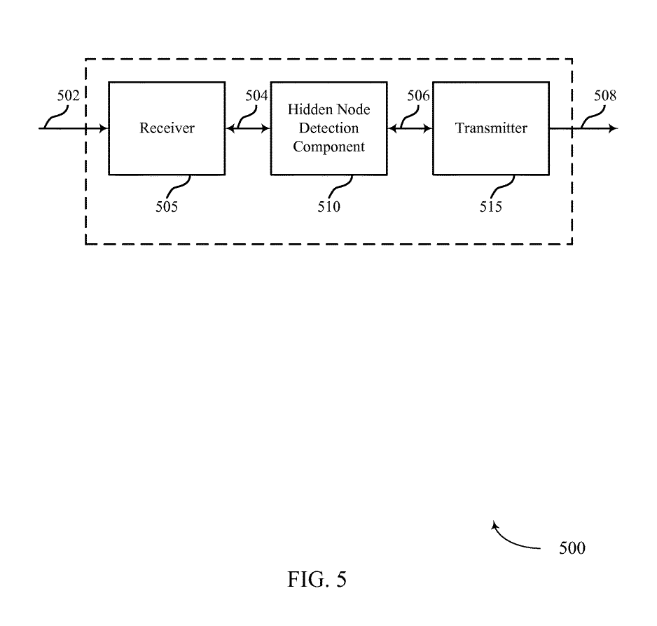

FIG. 5 shows a block diagram of a wireless device 500 configured for out-of-band hidden node detection in accordance with various aspects of the present disclosure. Wireless device 500 may be an example of aspects of a STA 115 or AP 105 described with reference to FIGS. 1-4. Wireless device 500 may include a receiver 505, a hidden node detection component 510, or a transmitter 515. Hidden node detection component 510 may be example of hidden node detection component 135 in reference to FIG. 1. Wireless device 500 may also include a processor. Each of these components may be in communication with each other.

The components of wireless device 500 may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The receiver 505 may receive information such as packets, user data, or control information associated with various information channels 502 (e.g., control channels, data channels, and information related to out-of-band hidden node detection, etc.). Information may be passed on to the hidden node detection component 510 via communication link 504, and to other components of wireless device 500.

The hidden node detection component 510 may transmit a first out-of-band signal, update a first list of one or more neighboring devices based on receiving a second out-of-band signal from one or more neighboring devices, receive, from one or more associated peers, a second list of one or more neighboring devices to the one or more associated peers, compare the first list to the second list, and change an operation mode based on the comparison. The hidden node detection component 510 may transmit the operation mode 506 to the transmitter 515.

The transmitter 515 may transmit signals 508 received from other components of wireless device 500. In some examples, the transmitter 515 may be collocated with the receiver 505 in a transceiver component. The transmitter 515 may include a single antenna, or it may include a plurality of antennas.

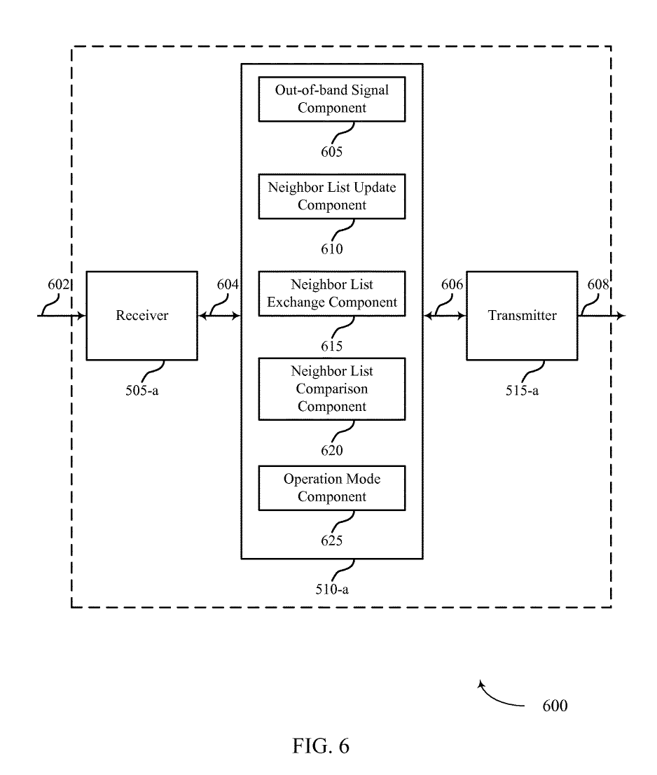

FIG. 6 shows a block diagram of a wireless device 600 for out-of-band hidden node detection in accordance with various aspects of the present disclosure. Wireless device 600 may be an example of aspects of a wireless device 500 or a STA 115 or AP 105 described with reference to FIGS. 1-5. Wireless device 600 may include a receiver 505-a, a hidden node detection component 510-a, or a transmitter 515-a. Hidden node detection component 510-a may be example of hidden node detection component 135 in reference to FIG. 1. Wireless device 600 may also include a processor. Each of these components may be in communication with each other. The hidden node detection component 510-a may also include an out-of-band signal component 605, a neighbor list update component 610, a neighbor list exchange component 615, a neighbor list comparison component 620, and an operation mode component 625. Out-of-band signal component 605 may be an example of out-of-band signal component 140 with reference to FIG. 1. Neighbor list exchange component 615 may be an example of neighbor list exchange component 145 with reference to FIG. 1.

The components of wireless device 600 may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The receiver 505-a may receive information from various information channels 602 that may be passed on to hidden node detection component 510-a, and to other components of wireless device 600 via communication link 604. The hidden node detection component 510-a may perform the operations described with reference to FIG. 5. The transmitter 515-a may transmit signals 608 received from other components via communication link 606 of wireless device 600.

The out-of-band signal component 605 may transmit a first out-of-band signal as described with reference to FIGS. 2-4. In some examples, the out-of-band signal may be transmitted on a Bluetooth low energy (BLE) channel. The out-of-band signal may contain a media access channel (MAC) address, a hashed MAC address, a basic service set identification (BSSID), a hashed BSSID, an operation band, a channel number, a channel bandwidth, or any combination thereof.

The neighbor list update component 610 may update a first list of one or more neighboring devices based on receiving a second out-of-band signal from one or more neighboring devices as described with reference to FIGS. 2-4. In some examples, the first list of one or more neighboring devices may include a media access channel (MAC) address, a hashed MAC address, a basic service set identification (BSSID), a hashed BSSID, an operation band, a channel number, a channel bandwidth, or any combination thereof for each neighbor.

The neighbor list exchange component 615 may receive, from one or more associated peers, a second list of one or more neighboring devices to the one or more associated peers as described with reference to FIGS. 2-4. The neighbor list exchange component 615 may also transmit the first list of one or more neighboring devices to the one or more associated peers in a Wi-Fi packet or a Bluetooth packet or a Bluetooth low-energy packet. The neighbor list exchange component 615 may also receive the second list of one or more neighboring devices to the one or more associated peers in a Wi-Fi packet or a Bluetooth packet or a Bluetooth low-energy packet.

The neighbor list comparison component 620 may compare the first list to the second list as described with reference to FIGS. 2-4. The neighbor list comparison component 620 may also compare the first list and the second list in order to identify one or more additional neighbors in the second list that are unlisted in the first list, where the one or more additional neighbors operating on an overlapping channel. In some examples, the one or more additional neighbors may be part of an overlapping basic service set.

The operation mode component 625 may change an operation mode based on the comparison as described with reference to FIGS. 2-4. The operation mode component 625 may determine whether to transmit a request to send (RTS) message before sending a data message. The operation mode component 625 may also change the operation mode such that wireless device 600 may transmit using a different operation bandwidth. In other cases, the operation mode component 625 may determine to transmit on a different operation band. In some examples, the operation mode may be different for the one or more associated peers.

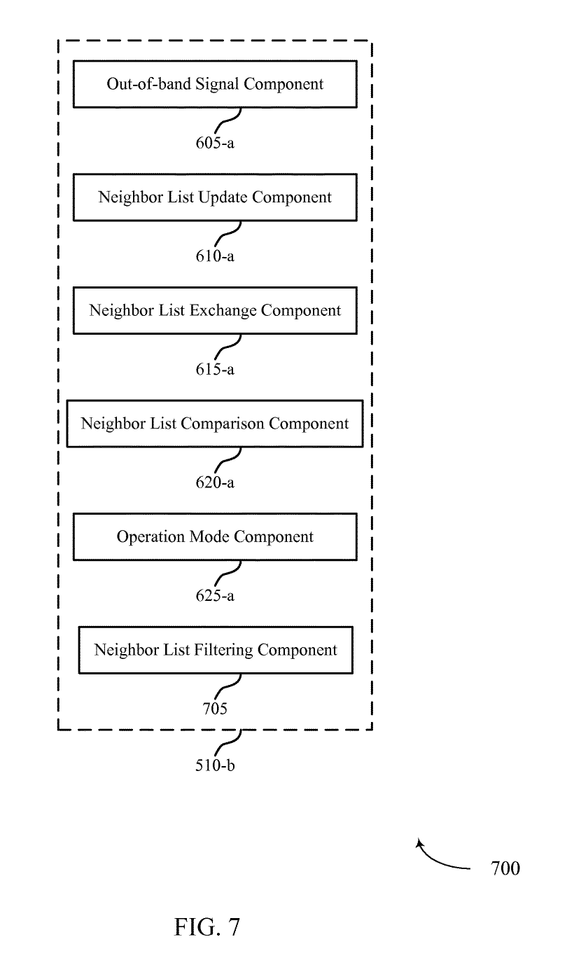

FIG. 7 shows a block diagram 700 of a hidden node detection component 510-b which may be a component of a wireless device 500 or a wireless device 600 for out-of-band hidden node detection in accordance with various aspects of the present disclosure. The hidden node detection component 510-b may be an example of aspects of a hidden node detection component 510 described with reference to FIGS. 5-6 or it may be an example of hidden node detection component 135 with reference to FIG. 1. The hidden node detection component 510-b may include an out-of-band signal component 605-a, a neighbor list update component 610-a, a neighbor list exchange component 615-a, a neighbor list comparison component 620-a, and an operation mode component 625-a. Each of these components may perform the functions described with reference to FIG. 6. Out-of-band signal component 605-a may be an example of out-of-band signal component 140 with reference to FIG. 1. Neighbor list exchange component 615-a may be an example of neighbor list exchange component 145 with reference to FIG. 1. The hidden node detection component 510-b may also include and a neighbor list filtering component 705.

The components of hidden node detection component 510-b may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The neighbor list filtering component 705 may filter the neighbor list based on predetermined criteria. For example, neighbor list filtering component 705 may exclude one or more neighboring devices from the first list based on a received signal strength indicator (RSSI) of the neighboring device being below a threshold or based on the neighbor's operation band as described with reference to FIGS. 2-4. The neighbor list filtering component 705 may also adjust the RSSI based on the radio access technology of the second out-of-band signal. For example, if the operation band is 2.4 GHz, the transmission power differences between Wi-Fi and BLE may be accounted for. The neighbor list filtering component 705 may also adjust the RSSI based on an operation band of the one or more neighboring device. For example, if the operation band is 5 GHz, the path loss difference between 5 GHz and 2.4 GHz may be accounted for. In this case, a predetermined adjustment or range of adjustment may be used, for example, 6-8 dB for 2.4 GHz and 5 GHz. In other cases, a node may ignore a neighboring device if the BLE RSSI is lower than a predetermined threshold.

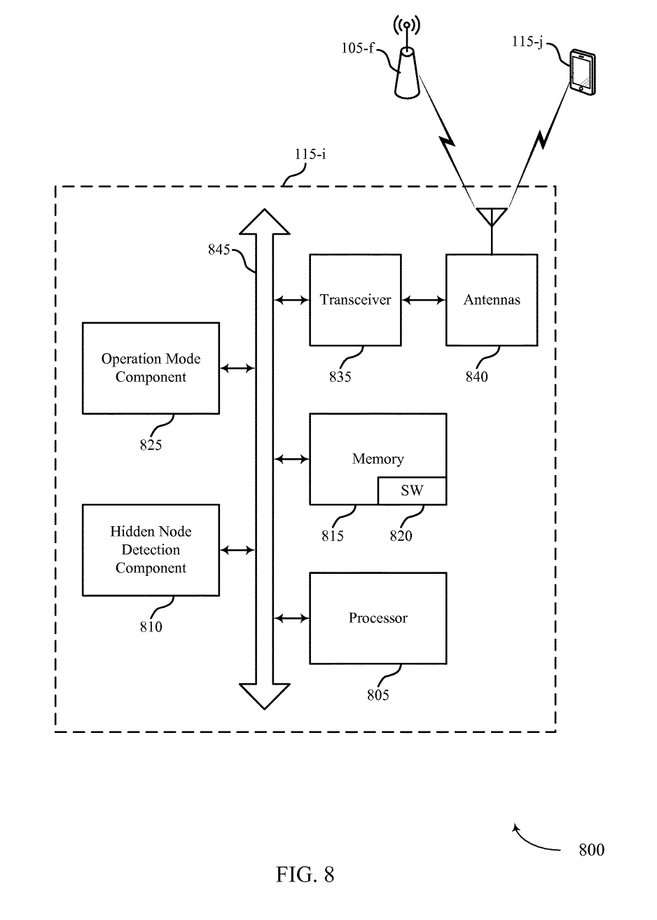

FIG. 8 shows a diagram of a system 800 including a STA 115 configured for out-of-band hidden node detection in accordance with various aspects of the present disclosure. System 800 may include STA 115-i, which may be an example of a wireless device 500, a wireless device 600, or a STA 115 or AP 105 described with reference to FIGS. 1-7. STA 115-i may include a hidden node detection component 810, which may be an example of a hidden node detection component 510 described with reference to FIGS. 5-7 or an example of hidden node detection component 135 with reference to FIG. 1. STA 115-i may also include an operation mode component 825. STA 115-i may also include components for bi-directional voice and data communications including components for transmitting communications and components for receiving communications. For example, STA 115-i may communicate bi-directionally with STA 115-j or AP 105-f.

Operation mode component 825 may change the operation mode of STA 115-i based on the comparison of neighbor lists. This may include determining whether to implement RTS/CTS, determining whether to change the operation bandwidth, or determining whether to change the operation band. Operation mode component 825 may be an example of operation mode component 625 with reference to FIGS. 6 and 7.

STA 115-i may also include a processor 805, and memory 815 (including software (SW) 820), a transceiver 835, and one or more antenna(s) 840, each of which may communicate, directly or indirectly, with one another (e.g., via buses 845). The transceiver 835 may communicate bi-directionally, via the antenna(s) 840 or wired or wireless links, with one or more networks, as described above. For example, the transceiver 835 may communicate bi-directionally with a AP 105 or another STA 115. The transceiver 835 may include a modem to modulate the packets and provide the modulated packets to the antenna(s) 840 for transmission, and to demodulate packets received from the antenna(s) 840. While STA 115-i may include a single antenna 840, STA 115-i may also have multiple antennas 840 capable of concurrently transmitting or receiving multiple wireless transmissions.

The memory 815 may include random access memory (RAM) and read only memory (ROM). The memory 815 may store computer-readable, computer-executable software/firmware code 820 including instructions that, when executed, cause the processor 805 to perform various functions described herein (e.g., out-of-band hidden node detection, etc.). Alternatively, the software/firmware code 820 may not be directly executable by the processor 805 but cause a computer (e.g., when compiled and executed) to perform functions described herein. The processor 805 may include an intelligent hardware device, (e.g., a central processing unit (CPU), a microcontroller, an application specific integrated circuit (ASIC), etc.)

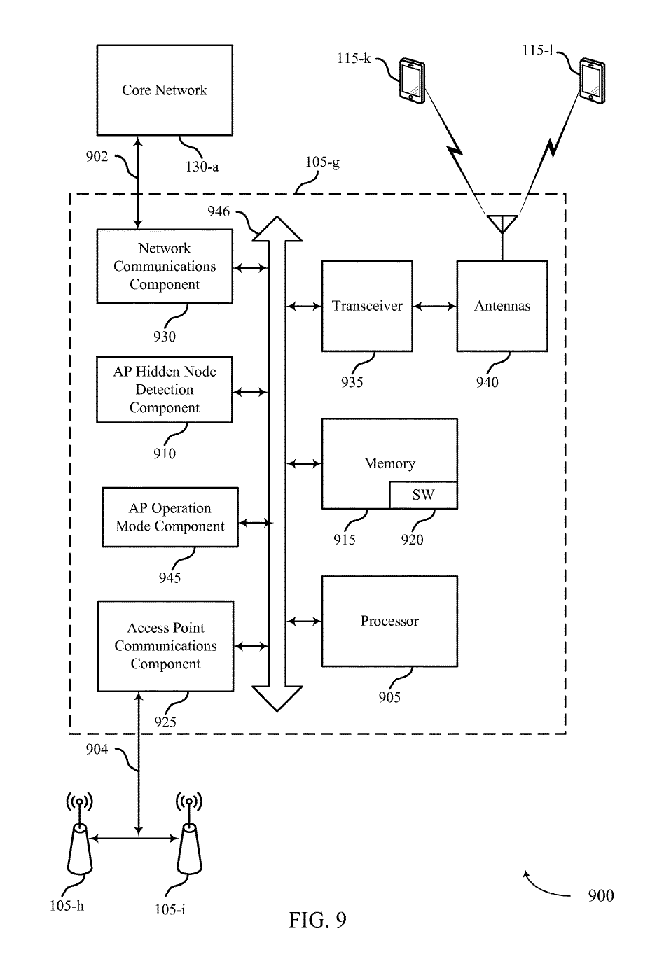

FIG. 9 shows a diagram of a system 900 including an AP 105 configured for out-of-band hidden node detection in accordance with various aspects of the present disclosure. System 900 may include AP 105-g, which may be an example of a wireless device 600, a hidden node detection component 510-b, or an AP 105 described with reference to FIGS. 1-8. AP 105-g may include an AP hidden node detection component 910, which may be an example of a hidden node detection component 135 described with reference to FIG. 1. AP 105-g may also include components for bi-directional voice and data communications including components for transmitting communications and components for receiving communications. For example, AP 105-g may communicate bi-directionally with STA 115-k or STA 115-l.

In some cases, AP 105-g may have one or more wired backhaul links. For example, AP 105-g may have a wired backhaul link 902 to a core network. AP 105-g may also communicate with other APs or APs 105, such as AP 105-h and AP 105-i via backhaul links 904. Each of the APs 105 may communicate with STAs 115 using the same or different wireless communications technologies. In some cases, AP 105-g may communicate with other APs such as AP 105-h or AP 105-i utilizing AP communications component 925. In some examples, AP communications component 925 may provide an X2 interface within a Long Term Evolution (LTE)/LTE-A wireless communication network technology to provide communication between some of the APs 105. In some cases, AP 105-g may communicate with the core network through network communications component 930.

The AP 105-g may include a processor 905, memory 915 (including software (SW) 920), transceiver 935, and antenna(s) 940, which each may be in communication, directly or indirectly, with one another (e.g., over bus system 946). The transceiver 935 may be configured to communicate bi-directionally, via the antenna(s) 940, with the STAs 115, which may be multi-mode devices. The transceiver 935 (or other components of the AP 105-g) may also be configured to communicate bi-directionally, via the antennas 940, with one or more other APs (not shown). The transceiver 935 may include a modem configured to modulate the packets and provide the modulated packets to the antennas 940 for transmission, and to demodulate packets received from the antennas 940. The AP 105-g may include multiple transceivers 935, each with one or more associated antennas 940. The transceiver may be an example of a combined receiver 505 and transmitter 515 of FIG. 5. AP 105-g may also include an AP operation mode component 945, which may change the operation mode of AP 105-g based on the comparison of neighbor lists. This may include determining whether to implement RTS/CTS, determining whether to change the operation bandwidth, or determining whether to change the operation band. AP operation mode component 945 may be an example of operation mode component 625 with reference to FIGS. 6 and 7.

The memory 915 may include RAM and ROM. The memory 915 may also store computer-readable, computer-executable software code 920 containing instructions that are configured to, when executed, cause the processor 905 to perform various functions described herein (e.g., out-of-band hidden node detection, selecting coverage enhancement techniques, call processing, database management, message routing, etc.). Alternatively, the software 920 may not be directly executable by the processor 905 but be configured to cause the computer, e.g., when compiled and executed, to perform functions described herein. The processor 905 may include an intelligent hardware device, e.g., a CPU, a microcontroller, an ASIC, etc. The processor 905 may include various special purpose processors such as encoders, queue processing components, base band processors, radio head controllers, digital signal processor (DSPs), and the like.

The AP communications component 925 may manage communications with other APs 105. In some cases, a communications management component may include a controller or scheduler for controlling communications with STAs 115 in cooperation with other APs 105. For example, the AP communications component 925 may coordinate scheduling for transmissions to STAs 115 for various interference mitigation techniques such as beamforming or joint transmission.

The components of wireless device 500, wireless device 600, and hidden node detection component 510, system 800, and system 900 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

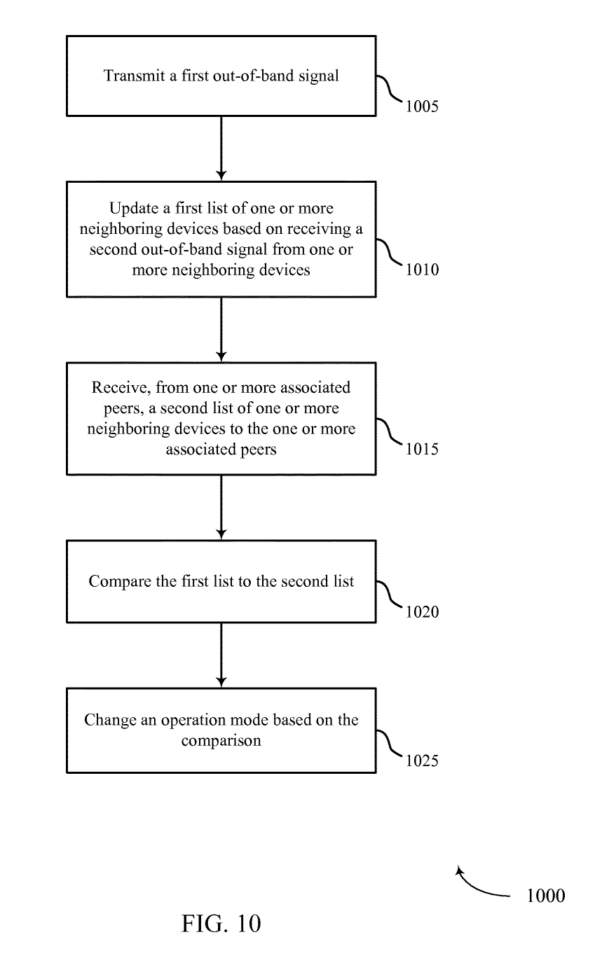

FIG. 10 shows a flowchart illustrating a method 1000 for out-of-band hidden node detection in accordance with various aspects of the present disclosure. The operations of method 1000 may be implemented by a STA 115 or AP 105 or its components as described with reference to FIGS. 1-9. For example, the operations of method 1000 may be performed by the hidden node detection component 510 as described with reference to FIGS. 5-8. In some examples, a STA 115 or AP 105 may execute a set of codes to control the functional elements of the STA 115 or AP 105 to perform the functions described below. Additionally or alternatively, the STA 115 or AP 105 may perform aspects of the functions described below using special-purpose hardware.

At block 1005, the STA 115 or AP 105 may transmit a first out-of-band signal as described with reference to FIGS. 2-4. In certain examples, the operations of block 1005 may be performed by the out-of-band signal component 605 as described with reference to FIG. 6.

At block 1010, the STA 115 or AP 105 may update a first list of one or more neighboring devices based on receiving a second out-of-band signal from one or more neighboring devices as described with reference to FIGS. 2-4. In certain examples, the operations of block 1010 may be performed by the neighbor list update component 610 as described with reference to FIG. 6.

At block 1015, the STA 115 or AP 105 may receive, from one or more associated peers, a second list of one or more neighboring devices to the one or more associated peers as described with reference to FIGS. 2-4. In certain examples, the operations of block 1015 may be performed by the neighbor list exchange component 615 as described with reference to FIG. 6.

At block 1020, the STA 115 or AP 105 may compare the first list to the second list as described with reference to FIGS. 2-4. In certain examples, the operations of block 1020 may be performed by the neighbor list comparison component 620 as described with reference to FIG. 6.

At block 1025, the STA 115 or AP 105 may change an operation mode based on the comparison as described with reference to FIGS. 2-4. In certain examples, the operations of block 1025 may be performed by the operation mode component 625 as described with reference to FIG. 6.

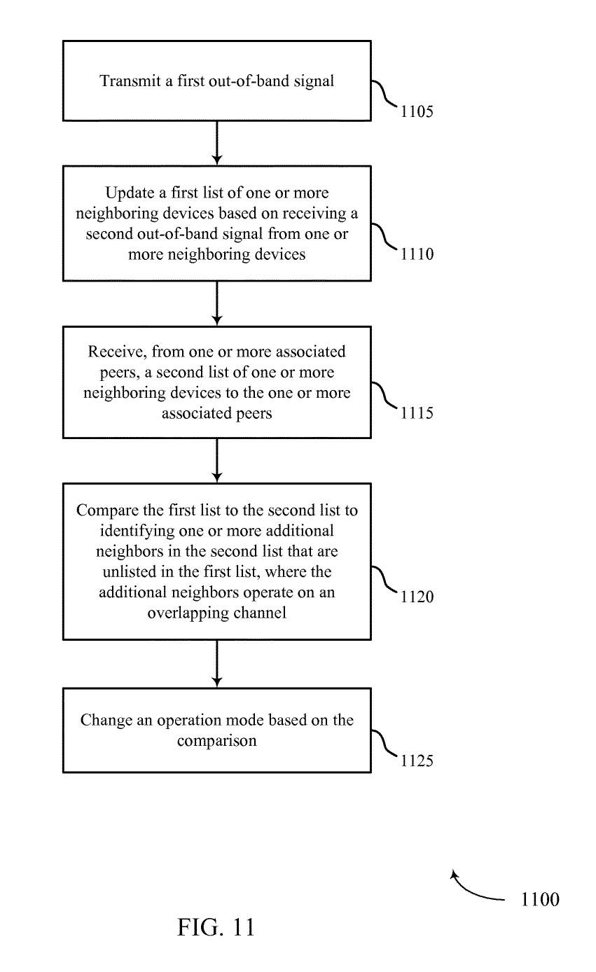

FIG. 11 shows a flowchart illustrating a method 1100 for out-of-band hidden node detection in accordance with various aspects of the present disclosure. The operations of method 1100 may be implemented by a STA 115 or AP 105 or its components as described with reference to FIGS. 1-9. For example, the operations of method 1100 may be performed by the hidden node detection component 510 as described with reference to FIGS. 5-8. In some examples, a STA 115 or AP 105 may execute a set of codes to control the functional elements of the STA 115 or AP 105 to perform the functions described below. Additionally or alternatively, the STA 115 or AP 105 may perform aspects of the functions described below using special-purpose hardware. The method 1100 may also incorporate aspects of method 1000 of FIG. 10.

At block 1105, the STA 115 or AP 105 may transmit a first out-of-band signal as described with reference to FIGS. 2-4. In certain examples, the operations of block 1105 may be performed by the out-of-band signal component 605 as described with reference to FIG. 6.

At block 1110, the STA 115 or AP 105 may update a first list of one or more neighboring devices based on receiving a second out-of-band signal from one or more neighboring devices as described with reference to FIGS. 2-4. In certain examples, the operations of block 1110 may be performed by the neighbor list update component 610 as described with reference to FIG. 6.

At block 1115, the STA 115 or AP 105 may receive, from one or more associated peers, a second list of one or more neighboring devices to the one or more associated peers as described with reference to FIGS. 2-4. In certain examples, the operations of block 1115 may be performed by the neighbor list exchange component 615 as described with reference to FIG. 6.

At block 1120, the STA 115 or AP 105 may compare the first list to the second list such that the STA 115 or AP 105 may identify one or more additional neighbors in the second list that are unlisted in the first list, where the additional neighbors operate on an overlapping channel as described with reference to FIGS. 2-4. In certain examples, the operations of block 1120 may be performed by the neighbor list comparison component 620 as described with reference to FIG. 6.

At block 1125, the STA 115 or AP 105 may change an operation mode based on the comparison as described with reference to FIGS. 2-4. In certain examples, the operations of block 1125 may be performed by the operation mode component 625 as described with reference to FIG. 6.

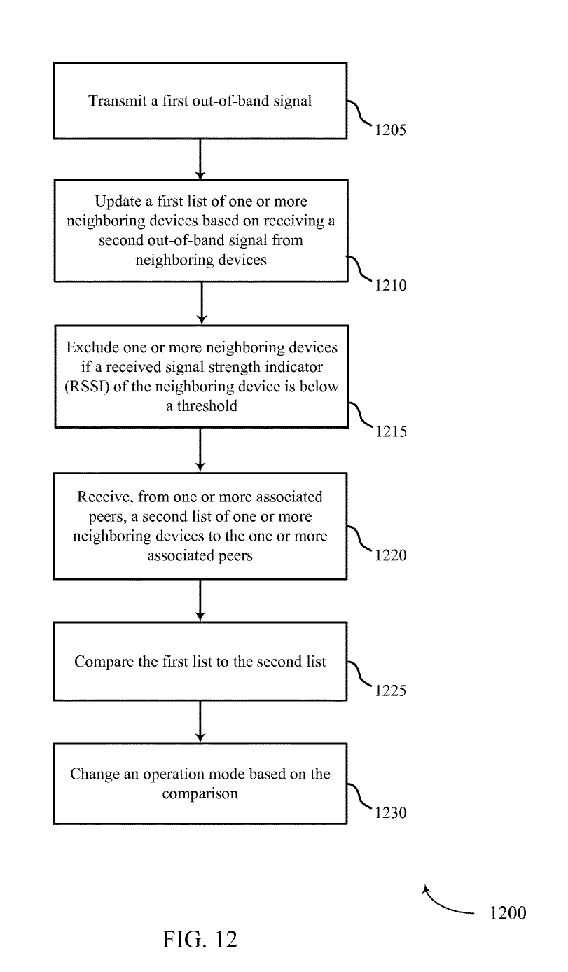

FIG. 12 shows a flowchart illustrating a method 1200 for out-of-band hidden node detection in accordance with various aspects of the present disclosure. The operations of method 1200 may be implemented by a STA 115 or AP 105 or its components as described with reference to FIGS. 1-9. For example, the operations of method 1200 may be performed by the hidden node detection component 510 as described with reference to FIGS. 5-8. In some examples, a STA 115 or AP 105 may execute a set of codes to control the functional elements of the STA 115 or AP 105 to perform the functions described below. Additionally or alternatively, the STA 115 or AP 105 may perform aspects of the functions described below using special-purpose hardware. The method 1200 may also incorporate aspects of methods 1000, and 1100 of FIGS. 10-11.

At block 1205, the STA 115 or AP 105 may transmit a first out-of-band signal as described with reference to FIGS. 2-4. In certain examples, the operations of block 1205 may be performed by the out-of-band signal component 605 as described with reference to FIG. 6.

At block 1210, the STA 115 or AP 105 may update a first list of one or more neighboring devices based on receiving a second out-of-band signal from one or more neighboring devices as described with reference to FIGS. 2-4. In certain examples, the operations of block 1210 may be performed by the neighbor list update component 610 as described with reference to FIG. 6

At block 1215, the STA 115 or AP 105 may exclude one or more neighboring devices from the first list based on a received signal strength indicator (RSSI) of the neighboring device being below a threshold as described with reference to FIGS. 2-4. In certain examples, the operations of block 1215 may be performed by the neighbor list filtering component 705 as described with reference to FIG. 7.

At block 1220, the STA 115 or AP 105 may receive, from one or more associated peers, a second list of one or more neighboring devices to the one or more associated peers as described with reference to FIGS. 2-4. In certain examples, the operations of block 1220 may be performed by the neighbor list exchange component 615 as described with reference to FIG. 6.

At block 1225, the STA 115 or AP 105 may compare the first list to the second list as described with reference to FIGS. 2-4. In certain examples, the operations of block 1225 may be performed by the neighbor list comparison component 620 as described with reference to FIG. 6.

At block 1230, the STA 115 or AP 105 may change an operation mode based on the comparison as described with reference to FIGS. 2-4. In certain examples, the operations of block 1230 may be performed by the operation mode component 625 as described with reference to FIG. 6.

Thus, methods 1000, 1100, and 1200 may provide for out-of-band hidden node detection. It should be noted that methods 1000, 1100, and 1200 describe possible implementation, and that the operations and the steps may be rearranged or otherwise modified such that other implementations are possible. In some examples, aspects from two or more of the methods 1000, 1100, and 1200 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
transmitting a first out-of-band signal;
updating a first list of one or more neighboring devices based at least in part on receiving a second out-of-band signal from the one or more neighboring devices;
receiving, from one or more associated peers, a second list of one or more neighboring devices to the one or more associated peers;
comparing the first list to the second list; and
changing an operation mode based at least in part on the comparison.

2. The method of claim 1, wherein the first out-of-band signal is transmitted on a Bluetooth low energy (BLE) channel.

3. The method of claim 1, wherein the first out-of-band signal comprises a media access channel (MAC) address, a hashed medium access control (MAC) address, a basic service set identification (BSSID), a hashed BSSID, an operation band, a channel number, a channel bandwidth, or any combination thereof.

4. The method of claim 1, wherein the first list of the one or more neighboring devices comprises a media access channel (MAC) address, a hashed MAC address, a basic service set identification (BSSID), a hashed BSSID, an operation band, a channel number, a channel bandwidth, or any combination thereof for each neighbor.

5. The method of claim 1, wherein comparing the first list and the second list comprises:
identifying one or more additional neighbors in the second list that are unlisted in the first list, the one or more additional neighbors operating on an overlapping channel.

6. The method of claim 5, wherein the one or more additional neighbors are part of an overlapping basic service set.

7. The method of claim 1, wherein changing the operation mode comprises:
determining whether to transmit a request to send (RTS) message before sending a data message.

8. The method of claim 1, wherein changing the operation mode comprises:
determining whether to transmit using a different operation bandwidth.

9. The method of claim 1, wherein changing the operation mode comprises:
determining whether to transmit on a different operation band.

10. The method of claim 1, wherein the operation mode is different for the one or more associated peers.

11. The method of claim 1, further comprising:
excluding one or more neighboring devices from the first list based at least in part on a received signal strength indicator (RSSI) of the neighboring device being below a threshold.

12. The method of claim 11, further comprising:
adjusting the RSSI based at least in part on a radio access technology of the second out-of-band signal.

13. The method of claim 11, further comprising:
adjusting the RSSI based at least in part on an operation band of the one or more neighboring device.

14. The method of claim 1, further comprising:
transmitting the first list of the one or more neighboring devices to the one or more associated peers in a Wi-Fi packet or a Bluetooth packet or a Bluetooth low-energy packet.

15. The method of claim 1, further comprising:
receiving the second list of one or more neighboring devices to the one or more associated peers in a Wi-Fi packet or a Bluetooth packet or a Bluetooth low-energy packet.

16. An apparatus for wireless communication, comprising:
a processor;
memory in electronic communication with the processor; and
instructions stored in the memory and operable, when executed by the processor, to cause the apparatus to:
transmit a first out-of-band signal;
update a first list of one or more neighboring devices based at least in part on receiving a second out-of-band signal from the one or more neighboring devices;
receive, from one or more associated peers, a second list of one or more neighboring devices to the one or more associated peers;
compare the first list to the second list; and
change an operation mode based at least in part on the comparison.

17. The apparatus of claim 16, wherein the first out-of-band signal is transmitted on a Bluetooth low energy (BLE) channel.

18. The apparatus of claim 16, wherein the first out-of-band signal comprises a media access channel (MAC) address, a hashed medium access control (MAC) address, a basic service set identification (BSSID), a hashed BSSID, an operation band, a channel number, a channel bandwidth, or any combination thereof.

19. The apparatus of claim 16, wherein the instructions are operable to cause the apparatus to:
compare the first list and the second list comprises identifying one or more additional neighbors in the second list that are unlisted in the first list, the one or more additional neighbors operating on an overlapping channel.

20. The apparatus of claim 16, wherein the instructions are operable to cause the apparatus to:
change the operation mode comprises determining whether to transmit a request to send (RTS) message before sending a data message.

21. The apparatus of claim 16, wherein the instructions are operable to cause the apparatus to:
change the operation mode comprises determining whether to transmit using a different operation bandwidth.

22. The apparatus of claim 16, wherein the instructions are operable to cause the apparatus to:
change the operation mode comprises determining whether to transmit on a different operation band.

23. The apparatus of claim 16, wherein the operation mode is different for the one or more associated peers.

24. The apparatus of claim 16, wherein the instructions are operable to cause the apparatus to:
exclude the one or more neighboring devices from the first list based at least in part on a received signal strength indicator (RSSI) of the neighboring device being below a threshold.

25. The apparatus of claim 24, wherein the instructions are operable to cause the apparatus to:
adjust the RSSI based at least in part on a radio access technology of the second out-of-band signal.

26. The apparatus of claim 16, wherein the instructions are operable to cause to:
transmit the first list of the one or more neighboring devices to the one or more associated peers in a Wi-Fi packet or a Bluetooth packet or a Bluetooth low-energy packet.

27. An apparatus for wireless communication, comprising:
an out-of-band signal component to transmit a first out-of-band signal;
a neighbor list update component to update a first list of one or more neighboring devices based at least in part on receiving a second out-of-band signal from the one or more neighboring devices;
a neighbor list exchange component to receive, from one or more associated peers, a second list of one or more neighboring devices to the one or more associated peers;
a neighbor list comparison component to compare the first list to the second list; and
an operation mode component to change an operation mode based at least in part on the comparison.

28. The apparatus of claim 27, further comprising:
the neighbor list comparison component to compare the first list and the second list comprises identifying one or more additional neighbors in the second list that are unlisted in the first list, the one or more additional neighbors operating on an overlapping channel.

29. The apparatus of claim 27, further comprising:
the operation mode component to change the operation mode comprises determining whether to transmit a request to send (RTS) message before sending a data message.

30. A non-transitory computer-readable medium storing code for wireless communication, the code comprising instructions executable to:
transmit a first out-of-band signal;
update a first list of one or more neighboring devices based at least in part on receiving a second out-of-band signal from the one or more neighboring devices;
receive, from one or more associated peers, a second list of one or more neighboring devices to the one or more associated peers;
compare the first list to the second list; and
change an operation mode based at least in part on the comparison.
